(19) United States
(12) Patent Application Publication
(10) Pub. No.: US 2007/0278051 A1
(43) Pub. Date: Dec. 6, 2007

(54) Method and Device for Actuating Braking Means of a Vehicle

(75) Inventors: Peter Hille, Stuttgart (DE); Wolfgang Lauer, Heilbronn (DE); Volker Schmid, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/578,952

(22) PCT Filed: Apr. 12, 2005
(86) PCT No.: PCT/EP05/03812

§ 371 Date: Jun. 28, 2007

(30) Foreign Application Priority Data
Apr. 20, 2004 (DE) 10 2004 018 949.8

(51) Int. Cl. B60T 7/12

(52) U.S. Cl. 188/135

(57) ABSTRACT

In a method and a device for vehicle brake actuation, braking can be actuated as a function of a driver's default value, which can be set by the driver of the vehicle. The default value can be set, in such a way that a braking force dependent on the driver's default value is generated. The braking force actually generated is modified independently of the driver in order to execute an automatic braking sequence when a predefined triggering condition is fulfilled. A limit value for the braking force is determined as a function of the driver's default value, and braking during execution of the automatic braking sequence is actuated independently of the driver in such a way that the modified braking force generated does not quantitatively exceed the limit value determined.

### BACKGROUND AND SUMMARY OF THE INVENTION

This invention relates to a method and a device for actuating braking means of a vehicle, in which the braking means can be actuated as a function of a driver's default value, which can be set by the driver of the vehicle. The braking means can be actuated in such a way that a braking force dependent on the driver's default value is generated in the braking means, and the braking force actually generated in the braking means is modified independently of the driver in order to execute an automatic braking sequence when a predefined triggering condition is fulfilled.

Such a method for reducing the braking distance of a vehicle in critical driving situations is disclosed by German document DE 198 17 326 A1. The vehicle has a brake booster, which during a standard braking sequence is actuated solely by a brake pedal pressure exerted by the driver of the vehicle and which in a critical driving situation is influenced by a control unit in such a way that a boost factor in excess of the standard braking sequence prevails on the brake booster. This leads to a corresponding increase in the vehicle deceleration predetermined by the driver through the brake pedal pressure exerted. In conventional emergency braking or brake assist systems, in the event of a triggering condition indicative of a critical driving situation being fulfilled, an automatic emergency braking sequence in the form of a drastic braking is executed with an intensity independent of the driver. The method described here, by contrast, allows the driver to influence the deceleration exerted on the vehicle by varying the bake pedal pressure in the usual way, even during the execution of such an emergency braking sequence.

The object of the present invention is to create an alternative method and an alternative device, which allows the driver to influence the deceleration exerted on the vehicle in the usual way, even during the execution of an automatic braking sequence.

This object is achieved by a method and a device according to the characteristic features of the claimed invention.

In the method for actuating braking means of a vehicle, the braking means can be actuated as a function of a driver's default value—such as a brake pedal position—which can be set by the driver of the vehicle, in such a way that a braking force dependent on the driver's default value is generated in the braking means. The braking force actually generated in the braking means is modified independently of the driver in order to execute an automatic braking sequence when a predefined triggering condition is fulfilled. For example, an automatic braking sequence with maximum braking force can be executed irrespective of the driver's current default value. According to the invention a limit value for the braking force is determined as a function of the driver's default value. The braking means during the execution of the automatic braking sequence is actuated independently of the driver in such a way that the modified braking force generated in the braking means does not quantitatively exceed the limit value determined. The modified braking force is therefore limited by the limit value determined to large quantities, and remains unaffected in the case of quantities less than or equal to the limit value determined. As previously mentioned, on fulfillment of a triggering condition indicative of a critical driving situation, conventional emergency braking or brake assist systems execute an automatic braking sequence in which the braking means are actuated, independently of the driver, in such a way that a substantially predefined braking force, generally the maximum possible braking force, is generated in said braking means. The limit placed on the braking force generated in the braking means and adjustable as a function of the driver's default value then allows the driver, even in the event of such a braking sequence, to influence the maximum braking force and indirectly also the maximum deceleration exerted on the vehicle by operating the brake operating element in the usual way.

The method according to the invention can be easily and if necessary also retroactively implemented in conventional emergency braking and brake assist systems of any type, since this can be accomplished without structural modifications by supplementing or modifying the control unit software.

Advantageous embodiments of the method according to the invention are claimed as well.

The driver's default value advantageously describes an operation by the driver of a brake operating element intended for the actuation of the braking means. The use of a conventional and hence intuitively operated brake pedal, operation of which by the driver can be reliably detected on the basis of a brake pedal deflection or brake pedal force generated by the driver, lends itself to this purpose. Instead of a brake pedal, a brake operating element of some other type might also be provided. One particular possibility is a control “side stick” or the like. The braking force generated in the braking means relates, for example, to a brake torque prevailing in wheel brake devices of the vehicle and/or to a brake pressure prevailing in pressure-operated wheel brake devices of the vehicle. Since the brake torque and brake pressure can be controlled or regulated with a high degree of accuracy, the braking means can be controllably actuated for corresponding execution of a braking sequence.

The triggering condition is advantageously predefined in such a way that fulfillment thereof leads to the inference of an imminent vehicle impact with an obstacle situated in the path of the moving vehicle, in particular a vehicle driving in front. Depending on what form the triggering condition takes, it can be used to implement either a brake assist system, a distance control or an emergency braking system. In the case of the brake assist system, the triggering condition typically incorporates variables which describe the operation by the driver of the brake operating element and/or a drive control element intended for actuation of drive means of the vehicle, whilst in the context of the distance control or the emergency braking system account is usually taken of variables which characterize the distance between the vehicle and the obstacle situated in the path of the moving vehicle. Further details relating to the precise form of the triggering condition are set forth in German documents DE 199 39 817 A1, DE 332 57 13 A1, and DE 196 47 430 A1, and elsewhere.

For defined actuation of the braking means, it is advantageous if the interdependence between the driver's default value and the limit value for the braking force is based upon a predetermined functional correlation. In the simplest case the functional correlation takes the form of a proportionality between the driver's default value and the limit value for the braking force, although this may also take any other form appropriate to the respective purpose.

The method according to the invention and the device according to the invention will be explained in more detail below with reference to the drawings attached.

### BRIEF DESCRIPTION OF THE DRAWINGS

FIG. 1 shows an exemplary embodiment of the method according to the invention in the form of a flow chart, and

FIG. 2 shows a schematic diagram of an exemplary embodiment of the device according to the invention.

### DETAILED DESCRIPTION OF THE INVENTION

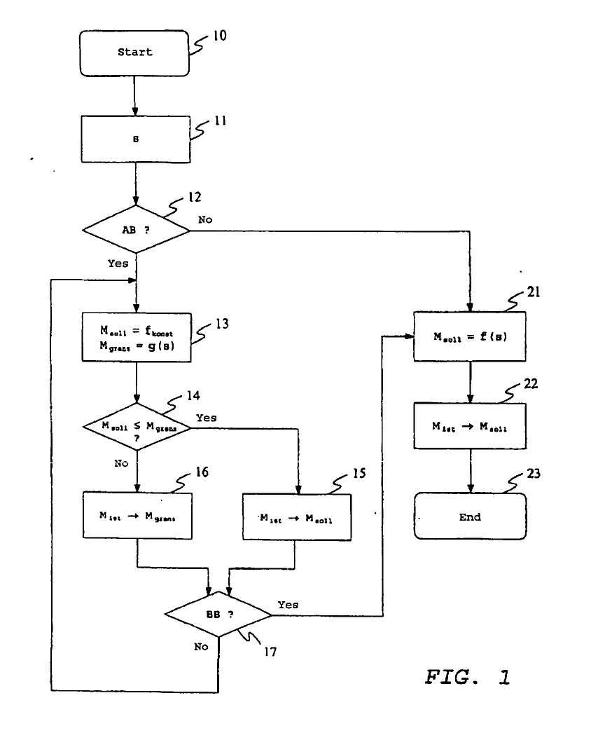

FIG. 1 shows an exemplary embodiment of the method according to the invention for actuating braking means of a vehicle.

The method according to the invention starts with an initialization step 10, followed by a first main step 11 in which a driver's default value s is determined, which describes an operation by the driver of a brake operating element intended for the actuation of the braking means. In a second main step 12 it is additionally analyzed whether a predefined triggering condition AB is fulfilled, fulfillment of this condition being indicative of an imminent vehicle impact with an obstacle situated in the path of the moving vehicle, in particular a vehicle driving in front. Depending on the form of the triggering condition AB and the variables incorporated therein, a brake assist system, a distance control or an emergency braking system can be implemented, the operating principle of the method according to the invention being independent of the precise form of the triggering condition AB, so that this will not be explored further here.

If in the second main step 12 it is determined that the predefined triggering condition AB is not fulfilled, a set point value Mₛₒₗₗ of a braking force that can be generated in the braking means is determined in a first secondary step 21. The set point value Mₛₒₗₗ of the braking force is determined as a function of the driver's default value s determined in the first main step 11, that is to say on the basis of a predetermined functional correlation Mₛₒₗₗ=f(s) between the set point value Mₛₒₗₗ of the braking force and the driver's default value s. In a second main step 22 the braking means are actuated in such a way that a braking force, corresponding to the previously determined set point value Mₛₒₗₗ and intended to be described, for example, by an actual value Mᵢₛₜ of the braking force, is generated in said braking means. The method is then terminated in a final step 23.

The braking force generated in the braking means here relates, for example, to a brake torque prevailing in wheel brake devices of the vehicle. The deceleration exerted on the vehicle in this case increases with the value of the brake force generated in the braking means. Instead of the brake torque it may also relate to a brake pressure prevailing in pressure-operated wheel brake devices of the vehicle or to a variable correlated therewith, in particular, a braking force.

The two secondary steps 21 and 22 correspond to a standard braking sequence performed by the driver. In contrast to this, an automatic braking sequence is initiated when it is detected in the second main step 12 that the predefined triggering condition AB is fulfilled. For this purpose, in an ensuing third main step 13 the set point value Mₛₒₗₗ of the braking force is equated to a constant fₖₒₙₛₜ predefined for performing the automatic braking sequence, resulting in a set point value Mₛₒₗₗ=fₖₒₙₛₜ for the braking force that is generally modified in comparison to the set point value Mₛₒₗₗ=f(s) determined in the first secondary step 21. The constant fₖₒₙₛₜ is invariant only in relation to the driver's default value s and depending on the intended purpose of the method according to the invention may also be a function of the time or other variables.

In parallel with this, in a third main step 13 a limit value M_{grenz} for the braking force is determined as a function of the driver's default value s, said limit value having been determined on the basis of a predefined functional correlation M_{grenz}=g(s). The functional correlation M_{grenz}=g(s) occurs, for example, in the form of a proportionality between the driver's default value s and the limit value M_{grenz} of the braking force. In a fourth main step 14 it is then analyzed whether the limit value M_{grenz} determined exceeds the set point value Mₛₒₗₗ=fₖₒₙₛₜ of the braking force predefined as constant in the preceding third main step 13.

If in the fourth main step 14 it is determined that the set point value Mₛₒₗₗ=fₖₒₙₛₜ predefined as constant in the third main step 13 is less than or equal to the limit value M_{grenz} determined for the braking force, the method continues with a fifth main step 15 in which the braking means are actuated independently of the driver in such a way that the actual value Mᵢₛₜ assumes the set point value Mₛₒₗₗ=fₖₒₙₛₜ for the braking force predefined as constant in the third main step 13.

If in the fourth main step 14 it is determined on the other hand that the set point value Mₛₒₗₗ=fₖₒₙₛₜ predefined as constant in the third main step 13 is greater than the limit value M_{grenz} for the braking force determined as a function of the driver's default value s, the method continues with a sixth main step 16 in which the braking means of the vehicle are actuated independently of the driver in such a way that the actual value Mᵢₛₜ of the braking force assumes the lesser limit value M_{grenz} for the braking force in comparison to the set point value Mₛₒₗₗ=fₖₒₙₛₜ predefined as constant in the third main step 13.

The fifth main step 15 and the sixth main step 16 are finally followed by a common seventh main step 17, in which it is analyzed whether a predefined termination condition BB is fulfilled, the automatic braking sequence being terminated on fulfillment of such a condition and the method for performing a standard braking sequence being continued in the first secondary step 21. If, on the other hand, the termination condition BB predefined in the seventh main step 17 is not fulfilled, the method returns to the third main step 13 to continue the automatic braking sequence. The termination condition BB incorporates the same variables as the triggering condition AB, for example.

The set point value Mₛₒₗₗ=fₖₒₙₛₜ of the braking force predefined as constant in the third main step 13 is therefore restricted by the limit value M_{grenz} determined for the braking force to large quantities. In the case of quantities less than or equal to the limit value M_{grenz} determined, on the other hand, it remains unaffected. The same also applies analogously to the braking force generated in the braking means of the vehicle described by the actual value Mᵢₛₜ.

The limit for the braking force generated in the braking means, which according to the invention can be taken as a function of the driver's default value s, allows the driver to influence the maximum braking force and hence the maximum deceleration exerted on the vehicle by operating the bake operating element in the usual way, even in the case of an automatic braking sequence.

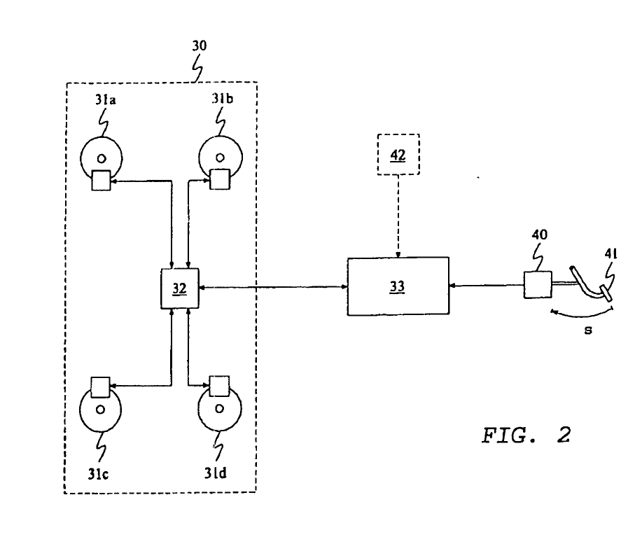

FIG. 2 shows a schematic diagram of an exemplary embodiment of the device according to the invention. In addition to the wheel brake devices 31a to 31d the braking means 30 of the vehicle comprise a braking means control 32, which is intended for actuating the wheel brake devices 31a to 31d and which can in turn be actuated by a control unit 33, so that it is possible for the driver to actuate the wheel brake devices 31a to 31d by means of the control unit 33.

A brake operating element sensor 40 is also provided, which registers operation of the brake operating element 41 by the driver in the form of the driver's default value s and generates corresponding signals, which are fed to the control unit 33 for evaluation. The brake operating element 41 is a conventional brake pedal, for example, and the driver's default value s is a brake pedal deflection or brake pedal force generated on the brake pedal by the driver.

The variables taken into account for the triggering condition AB are provided by a sensor arrangement 42, the control unit 33 determining on the basis of these whether or not the predefined triggering condition AB and the predefined termination condition BB are fulfilled. The variables referred to relate, for example, to the operation by the driver of the brake operating element 41 and/or of a drive operating element intended for the actuation of drive means of the vehicle, or to a distance occurring between the vehicle and an obstacle situated in the path of the moving vehicle. In order to register these variables the sensor arrangement 42 comprises suitable sensors, the signals from which are fed to the control unit 33.

1-6. (canceled)

7. A method for actuating a braking means of a vehicle, in which the braking means can be actuated as a function of a driver's default value, which can be set by a driver of the vehicle, in such a way that a braking force dependent on the driver's default value is generated in the braking means and the braking force actually generated in the braking means is modified independently of the driver in order to execute an automatic braking sequence when a predefined triggering condition is fulfilled, comprising:
determining a limit value for the braking force as a function of the driver's default value, and
actuating the braking means during execution of the automatic braking sequence independently of the driver in such a way that a modified braking force generated in the braking means does not quantitatively exceed the limit value determined.

8. The method as claimed in claim 7, wherein the driver's default value describes an operation by the driver of a brake operating element intended for the actuation of the braking means.

9. The method as claimed in claim 7, wherein the braking force generated in the braking means relates to a brake torque prevailing in wheel brake devices of the vehicle, to a brake pressure prevailing in pressure-operated wheel brake devices of the vehicle, or to both said brake torque and said brake pressure.

10. The method as claimed in claim 7, wherein the triggering condition is predefined in such a way that fulfillment thereof leads to an inference of an imminent vehicle impact with an obstacle situated in the path of the moving vehicle.

11. The method as claimed in claim 7, wherein interdependence between the driver's default value and the limit value for the braking force is based upon a predetermined functional correlation.

12. The method as claimed in claim 10, wherein the obstacle is another vehicle driving in front.

13. The method as claimed in claim 8, wherein the braking force generated in the braking means relates to a brake torque prevailing in wheel brake devices of the vehicle, to a brake pressure prevailing in pressure-operated wheel brake devices of the vehicle, or to both said brake torque and said brake pressure.

14. The method as claimed in claim 8, wherein the triggering condition is predefined in such a way that fulfillment thereof leads to an inference of an imminent vehicle impact with an obstacle situated in the path of the moving vehicle.

15. The method as claimed in claim 9, wherein the triggering condition is predefined in such a way that fulfillment thereof leads to an inference of an imminent vehicle impact with an obstacle situated in the path of the moving vehicle.

16. The method as claimed in claim 8, wherein interdependence between the driver's default value and the limit value for the braking force is based upon a predetermined functional correlation.

17. The method as claimed in claim 9, wherein interdependence between the driver's default value and the limit value for the braking force is based upon a predetermined functional correlation.

18. The method as claimed in claim 10, wherein interdependence between the driver's default value and the limit value for the braking force is based upon a predetermined functional correlation.

19. A device for executing vehicle braking comprising:
braking means which can be actuated as a function of a driver's default value and which can be set by the driver of the vehicle in such a way that a braking force dependent on the driver's default value is generated in the braking means, and
a control unit which is intended for actuation of the braking means by the driver and which modifies the braking force actually generated in the braking means in order to execute an automatic braking sequence when a predefined triggering condition is fulfilled,
wherein the control unit determines a limit value for the braking force as a function of the driver's default value, and
wherein the control unit actuates the braking means independently of the driver during execution of the automatic braking sequence in such a way that the modified braking force generated in the braking means does not quantitatively exceed the limit value determined.
